(19) United States
(12) Patent Application Publication
(10) Pub. No.: US 2016/0262418 A1
(43) Pub. Date: Sep. 15, 2016

(54) Full fat content non-alkalized shelf stable liquid chocolate processing methods and products

(71) Applicant: Cholaca, Inc., Boulder, CO (US)

(72) Inventors: Ira M. Leibtag, Boulder, CO (US); Brandon E. Shepherd, Aurora, CO (US)

(73) Assignee: Cholaca, Inc., Boulder, CO (US)

(21) Appl. No.: 14/544,966

(22) Filed: Mar. 9, 2015

(51) Int. Cl. A23G 1/56; A23G 1/00

(52) U.S. Cl. CPC A23G 1/56; A23G 1/0009

(57) ABSTRACT

Products and methods for processing cocoa to produce liquid chocolate without fat content or pH manipulation of the cocoa liquor ingredient. The methods include the steps of heating and mixing between about 16.5% to 20% by weight non-alkalized cocoa liquor, between about 55% to 80% by weight water, and between about 0% to 25% by weight sweetener to a homogenous mixture, UHT processing of the homogenous mixture at selected minimum temperature and exposure time, downstream homogenization at a selected minimum processing pressure, and further cooling for aseptic packaging.

### FIELD OF THE INVENTION

This invention relates to liquid chocolate products and manufacture and, more particularly, relates to such products and processing without pH or fat content manipulation (addition or reduction).

### BACKGROUND OF THE INVENTION

Various liquid chocolate flavored products have been heretofore known or suggested and are commercially popular. These have included chocolate milk and chocolate syrup products (see, for example, U.S. Pat. Nos. 2,189,144, 3,821,420 and 5,773,056). Most have preprocessed chocolate base for reduced fat content and/or alkalization, both of which are adapted to make the chocolate easier to blend in liquid. This compromises the flavor of the chocolate while yet, in some products, retaining the tendency for these mixtures to separate.

This tendency to agglomerate and separate is especially characteristic of chocolate having a high fat content (on the order of about 40% to 55% by weight and higher) and which is known as cocoa liquor. In such case the butter fat tends to agglomerate in relatively large globules and prevents homogeneous mixture. When a high fat content chocolate is melted the cocoa butter coalesces and separates into a distinct layer. This undesirable quality has made use of high fat content chocolate difficult in manufacturing applications.

The process of preparing a cocoa bean for use in manufacture includes cleaning, breaking and winnowing a selected bean blend. The breaking and winnowing steps separate the essential ingredient of the cocoa bean, the kernel, most often described as the nib, from its shell. The nibs are, like most farm products, microbiologically contaminated and thus require sterilization. After sterilization, the nib is roasted directly (natural process chocolate as used by this invention) or can be alkalized first (Dutching processing). Alkalizing (or Dutching) is a process for treating the cocoa nibs with an alkali solution such as potassium or sodium carbonate to modify the flavor and color of cocoa powder or cocoa liquor.

The roasting process reduces the water content and further develops flavor. Roasting is particularly important to the final flavor because the nib's flavor is formed from the precursors that developed during fermentation. The roasted nib is ground, often in a multi-stage process. Grinding breaks up the cell structure of the cocoa nibs and releases the cocoa butter resulting a fluid mass of cocoa particles suspended in cocoa butter due to the high fat content of the bean. The mass is passed through sieves. The sieved mass, or cake, is referred to as cocoa liquor.

Cocoa butter constitutes about half the weight of the cocoa nib. This fat is often partially removed from the cocoa liquor by means of hydraulic presses applying pressures as high as 450 kg/cm2. Depending upon the pressing time and the setting of the press, the resulting non-full fat cakes may have a fat content of 10 to 24 percent. In either case, the resulting cakes are broken into kibbled cake which is stored by fat content (and degree of alkalization) and may be blended before pulverization to obtain the desired type of cocoa powder.

It would in some cases be preferable that adjustment of the pH or fat content in processing of final product not occur. This would allow for a quicker and more natural processing of the product prior to packaging if correctly batched and processed. While most known liquid chocolate flavored products utilize reduced fat content alkalized chocolate, some processing methods have heretofore been suggested and or utilized for processing of full fat chocolate (see U.S. Pat. No. 2,189,144). However, these products are felt to me necessarily quite thick and are in fact referred to as a “magma” when heated, the water content being a minor proportion, typically 25% to 40% by weight, of the mixture. This would not be particularly well adapted to modern liquid processing and packaging techniques (modern aseptic cold fill techniques for example).

### SUMMARY OF THE INVENTION

This invention provides a shelf stable liquid chocolate that is produced without manipulation of cocoa liquor fat content or pH. The methods are readily adaptable to modern sterilization and packaging techniques and can be modified to control product viscosity to provide products of different texture or thickness (from readily pourable product to product with the consistency of mousse).

The methods for processing cocoa to produce full fat content shelf stable liquid chocolate include heating and mixing between about 16.5% to 20% by weight non-alkalized cocoa liquor, between about 55% to 80% by weight water, and between about 0% to 25% by weight sweetener to a homogenous mixture with a temperature of between about 110° and 155° F. Temperature of the homogenous mixture is processed through heat exchange to increase its temperature to between about 175° and 190° F. for UHT processing. UHT processing of the homogenous mixture proceeds rapidly at a selected temperature and for a selected short time. Preferably, UHT processing is at a minimum of about 289° F. for about 5 seconds after which the homogenous mixture is cooled followed by downstream homogenization at a minimum of 500 psi and further cooling to between about 40° and 80° F. for packaging.

Heating and mixing percentage of batched product may vary depending upon consistency and sweetness desired, but are preferably in one embodiment of the method about 17% full fat non-alkalized cocoa liquor, about 79% water, about 2.5% sweetener (preferably coconut sugar in this embodiment) or more depending upon desired sweetness. To assure a more pourable product, about 0.125% liquid cereal amylase is added during batching.

The full fat liquid chocolate product of this invention includes between about 16.5% to 20% non-alkalized cocoa liquor, between about 55% to 80% water, and between about 0% to 25% sweetener depending upon desired sweetness in a homogenous shelf stable mixture.

It is therefore an object of this invention to provide full fat content liquid chocolate processing methods and products.

It is another object of this invention to provide full fat content shelf stable liquid chocolate processing methods and products that are pourable.

It is still another object of this invention to provide a liquid chocolate product produced without manipulation of cocoa liquor fat content or pH.

It is yet another object of this invention to provide full fat content shelf stable liquid chocolate processing methods and products readily adaptable to modern sterilization and packaging techniques.

It is yet another object of this invention to provide full fat content shelf stable liquid chocolate processing methods and products having the consistency of mousse.

It is yet another object of this invention to provide a full fat content liquid chocolate having a viscosity between about 280 Centipoise and 30,000 Centipoise.

It is another object of this invention to provide a method for processing cocoa to produce full fat content liquid chocolate that includes the steps of heating and mixing between about 16.5% to 20% by weight cocoa liquor, between about 55% to 80% by weight water, and between about 0% to 25% by weight sweetener to a homogenous mixture at a temperature of between about 110° and 155° F., increasing the temperature of the homogenous mixture to between about 175° and 190° F., UHT processing of the homogenous mixture at a minimum of about 289° F. for about 5 seconds, and cooling the homogenous mixture after UHT processing followed by downstream homogenization at a minimum of 500 psi and further cooling to between about 40° and 80° F. for packaging.

It is still another object of this invention to provide a method for processing cocoa to produce full fat content shelf stable liquid chocolate that includes the steps of heating and mixing about 17% full fat cocoa liquor, about 79% water, about 2.5% coconut sugar or more depending upon desired sweetness, and about 0.125% liquid cereal amylase to provide a homogenous mixture, UHT processing of the homogenous mixture at a selected temperature and for a selected short time, homogenizing the UHT processed mixture at a minimum pressure of about 500 psi, and packaging the liquid chocolate thus processed.

It is yet another object of this invention to provide a full fat liquid chocolate product including between about 16.5% to 20% cocoa liquor, between about 55% to 80% water, and between about 0% to 25% sweetener depending upon desired sweetness.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the processing method of this invention according to the best mode so far devised for the practical application of the principles thereof, and in which:

FIG. 1 is a flow diagram illustrating one means for implementation of the methods of this invention and manufacture of the product of this invention.

### DESCRIPTION OF THE INVENTION

The methods of this invention are carried out in two stages, batching and processing/packaging utilizing UHT methods. This processing is specifically adapted to production of a homogeneous, liquid (defined as ranging from the consistency of a mousse to readily pourable in consistency) chocolate (beverage for example) created from undiminished or adulterated cocoa liquor.

In order to achieve this product, certain difficulties particular to processing of non-preprocessed cocoa had to be addressed and overcome. Natural starches in non-preprocessed cocoa have an accelerated bloom and absorption when exposed to UHT processing, causing an extremely high viscosity product (the consistency of mousse). While this may be desirable for some product types and/categories, others require and thinner consistency. In such cases, prevention of thickening during processing can be achieved by addition of alpha amylase during batching.

For example, where a thinner product is desired, batching of dry ingredients (cocoa liquor and sweetener—preferably coconut sugar) into an agitator-type blending vessel with the liquid component (water) results in a simple mixture of solids and liquids. There is no homogenization or water absorption at this point, and in the event that the agitator is turned off, all the solids would sink to the bottom of the tank with only the soluble material (sugar, for example) remaining in the liquid phase.

Starches in the raw ingredient (cocoa liquor) are initially presented as a tightly would ball of carbohydrate that needs to bloom (expand) in order to allow space for water to migrate in. They typically bloom at temperatures between 60-80C, which causes swelling of the starch and mixture thickening. All the water and dissolved solids are being trapped within the matrix of the starches. This usually takes several minutes to accomplish after the correct temperature has been achieved.

If the temperature rises too fast, such as is the case with UHT processing, starch bloom occurs in a matter of seconds, causing an extremely thick, yet homogenous finished product. This phenomenon is unique to this type of fluid processing, caused by the combination of high temperature and high pressure in the processing stage. The consistency is of a thick mousse having a viscosity of about 10,000 Centipoise to 30,000 Centipoise depending on batching proportions.

Where desired, to mitigate this issue alpha-amylase is added during batching to destroy starch granules prior to processing. Thus the starch bloom is initiated during batching by heating the mixture specifically to cause hydration of the starches found in the cocoa so that they can be destroyed by addition to the mixture of alpha-amylase enzyme. The consistency is of a thinner, more pourable liquid after processing, having a viscosity of about 280 Centipoise to 8,000 Centipoise depending on batching proportions.

The following is a preferred example of the methods for batching and processing, it being understood that if the thicker mousse-type product is desired all steps related to addition of alpha-amylase enzyme should be skipped. All ingredients are assemble is a blending tank. The preferably ingredient make-up includes, by weight, between about 16.5% to 20% full fat non-alkalized cocoa liquor (preferably about 17.23%), between about 55% to 80% water (preferably about 78.98%), and between about 0% to 25% sweetener (sugar or sugar substitute, preferably coconut sugar—preferably about 3.79%). Sugar content can be further increased depending upon product sweetness and consistency desired.

The products are blended while heating (to as high as 150° to 155° F.) and held at this temperature for approximately 15 minutes causing starch bloom and homogenization. For the thinner product, starch breakdown is encouraged by addition of a selected liquid amylase enzyme (preferably liquid cereal amylase) to the mixture in amounts of between about 0.01% and 0.13% by weight, preferably about 0.125%. Thereafter the mixture is cooled to as low as 110° F. (preferably to about 125° F.) while blending for about 30 minutes.

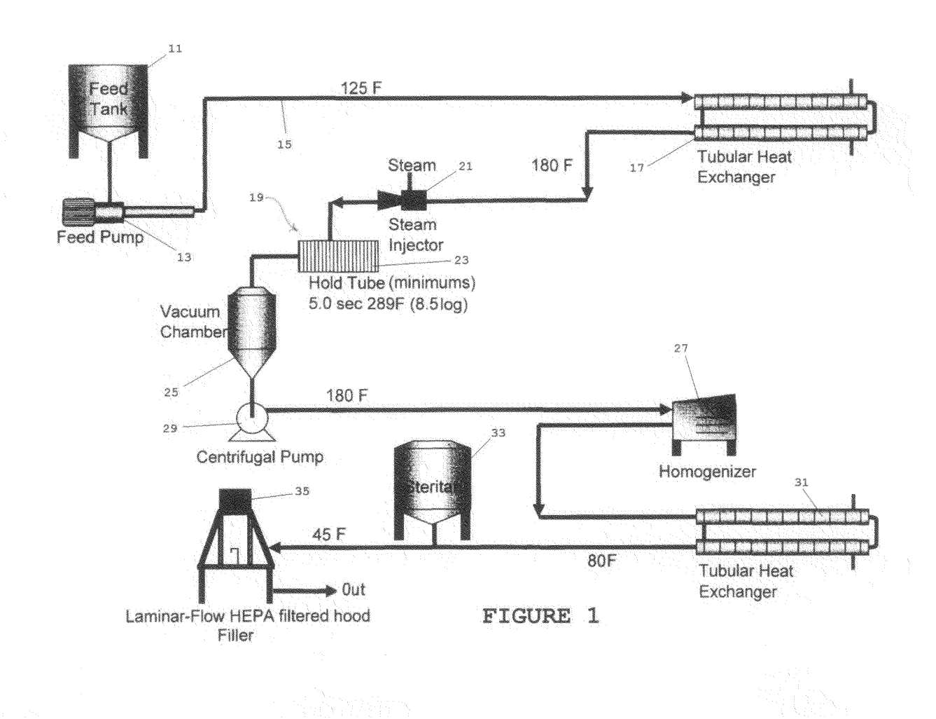

The mixture is then processed and packaged. Referring to FIG. 1, the prepared mixture is poured into a processing system feed tank 11 and pumped from tank 11 at about 120° to 125° F. by centrifugal pump 13 into system feed piping 15 and to tubular heat exchanger 17 (a monotube design, for example). Temperature of the mixture is raised at exchanger 17 to between about 175° and 190° F. (preferably about 180° F.).

While not shown, the mixture may be processed through a homogenizer after heat exchanged (using for example a Tetra Alex200 homogenizer, 1500 psi, 500 psi second stage). A progressive cavity pump is, in this case, used at the homogenizer output to feed the homogenous mixture to the thermal stage 19 of UHT processing including steam injector 21 for final heating, holding tube 23 and vacuum chamber 25. Final heating by steam injection (or other method as addressed below) is to a temperature of at least 289° F. for 5.0 seconds in holding tube 23. Chamber 25 is a flash chamber for vacuum cooling reducing the temperature of the mixture to between about 175° and 190° F. (preferably 180° F.) and removing the water added during steam injection.

Downstream homogenization to further smooth the product occurs at a minimum of 500 psi at homogenizer 27 fed by centrifugal pump 29. Thereafter, the homogenous mixture is cooled at tubular heat exchanger 31 to between about 75° and 80° F. and held at sterile tank 33 until cooled further (between about 40° and 50° F.). Aseptic packaging occurs at station 35 (preferably a laminar-flow HEPA filter hood and filler) wherein finished product is packaged in the desired sterile containment configuration. The finished product is full fat liquid chocolate including between about 16.5% to 20% cocoa liquor, between about 55% to 80% water, and between about 0% to 25% sweetener depending upon desired sweetness in a homogenous shelf stable mixture.

Alpha-amylase is a bioactive enzyme that cleaves gelatinized starch granules, causing the granule to lose its viscosity forming properties. When added after the starch bloom completion it prevents further molecular gelatinization (in this process particularly useful when proceeding to UHT processing for controlling thickening of the homogenous mixture). Agitation is required during amylase addition to maximize the potential for the enzymes to come in contact with the molecular substrate. Once the gelatinized starches have been broken down the viscosity will decrease and prevent unduly viscous finished product. The temperatures and pressures of the UHT and homogenizer processing systems will ultimately denature the alpha-amylase, rendering it useless post pasteurization. Bacterial or cereal alpha-amylase can be used, but liquid cereal amylase is preferred.

UHT processing of beverages includes two major steps, pasteurization and homogenization. Pasteurization temperatures which are typical of UHT processing reach 275° F., with a process time of only a few seconds, and is required for food safety. Homogenization can be adjusted from 500 psi to 2500 psi and may be applied in either one or two stage homogenization processors. Homogenization determines the particle size of any agglomeration.

There are two methods of thermal stage UHT processing. The direct method is shown in FIG. 1 and involves injecting steam into the product fluid stream, which is removed by a vacuum chamber at the end of the process. An indirect UHT processing method could as well be utilized (also called “shell in tube” processing) and has the fluid pumped through a pipe, which is surrounded by another pipe filled with steam. There is thus no need to remove the steam with latter processing though product cooling must be addressed.

A practical example of the batching and processing of the thick product follows. Various size production runs can be done depending upon available facilities. In one test run, yielding about 160 gallons, less purge amounts filled into 330 ml Prisma packs at 18 per case, about 42 bags (210 lbs.) of cacao liquor was batch into a kettle and completely melted at about 150°. About 15,400 fluid oz (or 1004 lbs.) of filtered water was added together with about 46.5 lbs. of coconut sugar. The mixture is agitated so complete emulsification occurs. UHT processing as described above follows resulting in a thick, mousse texture product.

As may be appreciated from the foregoing, the minimum thermal process for this product was 289° F. (chocolate) for 5.0 seconds, calculated using laminar flow and steam injection correction factors. This process yields a minimum Fₒ of 8.5 minutes (chocolate). F₀ is an expression of the sterilization time to ensure that whatever micro-organisms are contained within the process sample are reduced to an acceptable limit. This is a function of both time and temperature.

The product is packaged using, for example, the HEPA-filtered hood 35 under very clean conditions. The packages may be any commonly used packaged adapted to this purpose, for example pre-sterilized 1000 ml Nalgene bottles.

Table 1 shows parameter of two processing batch runs producing acceptable product.

TABLE A

| | | | Temperature ° F. | | | | | | | | | |
|---|---|---|---|---|---|---|---|---|---|---|---|---|
| | | Flow | | | Final | | Holding | | | | Final | |
| | | Rate | Preheater | | Heater | | Tube | | Precooler | | Cooler | |
| Batch | Processor | (GPM) | in | out | in | out | in | out | in | out | in | out |
| 1 | VTIS | 1.0 | 125 | 180 | 180 | 293 | 293 | 292 | 292 | 180 | 180 | 45 |
| 2 | VTIS | 1.0 | 125 | 180 | 180 | 293 | 293 | 292 | 292 | 180 | 180 | 45 |

As is apparent from the foregoing, liquid chocolate as used herein is defined to include products ranging from the consistency of mousse to a relatively thin pourable product, and preferably having a viscosity between about 280 Centipoise and 30,000 Centipoise (these measurements all being made a room temperature—approximately 70° F. Processing through a UHT processing system along with homogenization creates a unique product that is more viscous. The ratios of ingredients as well as the rigorous processing it is put through creates a very stable matrix. This matrix is able to hold an amazing amount of water while maintaining a mousse like texture, and no separation or syneresis. Processing with alpha-amylase enzyme at the batching stage before processing creates and thinner yet consistent product.

What is claimed is:

1. A method for processing cocoa to produce full fat content liquid chocolate comprising the steps of:
heating and mixing between about 16.5% to 20% by weight non alkalized cocoa liquor, between about 55% to 80% by weight water, and between about 0% to 25% by weight sweetener to a homogenous mixture at a temperature of between about 110° and 155° F.;
increasing the temperature of the homogenous mixture to between about 175° and 190° F.;
UHT processing of the homogenous mixture at sufficient temperature and for a sufficient time to sterilize the mixture; and
cooling the homogenous mixture after UHT processing followed by downstream homogenization at a minimum of 500 psi and further cooling to between about 40° and 80° F. for packaging.

2. The method of claim 1 wherein the cocoa liquor is preferably about 17.23% by weight, wherein the water is preferably about 78.98% by weight, and wherein the sweetener is preferably about 3.79% by weight.

3. The method of claim 1 wherein the UHT processing and subsequent cooling preferably includes steam injection into a holding tube containing the homogenous mixture followed by vacuum chamber cooling reducing the temperature to between about 175° and 190° F. and removing the water added during steam injection.

4. The method of claim 1 wherein the steps of increasing the temperature and of further cooling include in line heat exchange.

5. The method of claim 4 wherein the step of further cooling includes first stage reduction of temperature to between about 75° and 80° F., and second stage sterile tank retention to a temperature of between about 40° and 50° F.

6. The method of claim 1 wherein the UHT processing of the homogenous mixture at sufficient temperature and for sufficient time is at a minimum of about 289° F. for about 5 seconds.

7. A method for processing cocoa to produce full fat content shelf stable liquid chocolate comprising the steps of:
heating and mixing about 17% full fat non-alkalized cocoa liquor, about 79% water, about 2.5% coconut sugar or more depending upon desired sweetness, and about 0.125% liquid cereal amylase to provide a homogenous mixture;
UHT processing of the homogenous mixture at a selected temperature and for a selected short time;
homogenizing the UHT processed mixture at a minimum pressure of about 500 psi; and
packaging the liquid chocolate thus processed.

8. The method of claim 7 further comprising preheating and final cooling before UHT processing and after homogenizing, respectively.

9. The method of claim 7 wherein said liquid amylase is liquid cereal amylase.

10. The method of claim 7 wherein UHT processing includes steam injection into a holding tube containing the homogenous mixture followed by vacuum chamber cooling reducing the temperature to between about 175° and 190° F. and removing the water added during steam injection.

11. The method of claim 1 wherein said UHT processing temperature and time are selected for a minimum F₀ of about 8.5 minutes (chocolate).

12. The method of claim 7 wherein said packaging includes a laminar-flow HEPA filtering.

13. The method of claim 7 wherein UHT processing includes indirect UHT processing wherein the homogenous mixture is processed through a conduit jacketed by a steam filled pipe.

14. The product of claim 15 having a viscosity between about 280 Centipoise and 30,000 Centipoise.

15. A full fat liquid chocolate product comprising between about 16.5% to 20% non-alkalized cocoa liquor, between about 55% to 80% water, and between about 0% to 25% sweetener depending upon desired sweetness in a homogenous shelf stable mixture.

16. The product of claim 15 having the consistency of mousse.

17. The product of claim 15 having a pourable consistency.

18. The product of claim 15 having a viscosity between about 280 Centipoise and 30,000 Centipoise.

19. The product of claim 15 further comprising between about between about 0.01% and 0.13%, by weight cereal amylase.

20. The product of claim 15 wherein said cocoa liquor is preferably about 17.23% by weight, wherein water is preferably about 78.98% by weight, and where sweetener is coconut sugar preferably about 3.79% by weight of the product.
